(19) United States
(12) Patent Application Publication
(10) Pub. No.: US 2026/0318149 A1
(43) Pub. Date: Oct. 15, 2026

(54) FRAME FOR CEILING ACCESS PANEL

(71) Applicant: Doroger Ltd., Mazkeret Batya (IL)

(72) Inventors: Ilya Rozenberg, Ashdod (IL); Alex Dondysh, Rishon LeZion (IL)

(21) Appl. No.: 19/647,924

(22) Filed: Apr. 15, 2026

Related U.S. Application Data
(60) Provisional application No. 63/789,141, filed on Apr. 15, 2025.

(51) Int. Cl. E06B 3/964; E06B 1/52

(52) U.S. Cl. CPC E06B 3/9642; E06B 1/52

(57) ABSTRACT

Ceilings having access portals have increased structural integrity when the portal edges are framed for reinforcement. Often, the frames for this purpose have inner-extending surfaces to support portal covers/access panels. Disclosed herein is a frame for a ceiling access panel that includes four edge members and four corner members. The edge members wrap around top and bottom of the edges of the ceiling portals, and the corner members hold the edge members in place. The result in an improved access panel frame that does not require nailing, screwing, drilling, or bonding of frame materials to the ceiling but nonetheless increases the structural integrity of the ceiling in the vicinity of the portal.

### RELATED APPLICATION

This application claims benefit under 35 U.S.C. § 119(e) of the Apr. 15, 2025 filing of U.S. Provisional Application No. 63/789,141, which is hereby incorporated by reference in its entirety. If the prior application contains any inconsistencies with the present application, the claims are to be understood to be supported by the present application’s version of any supposed ambiguous subject matter.

### BACKGROUND

In many homes, offices, and industrial buildings, spaces exist between the ceilings of one story and the roof or the floor of the next story above. The spaces can be available for an attic for storage or ventilation systems, for electrical and communication systems, and for plumbing, as non-limiting examples. To access such spaces, for example, to add/retrieve items to/from storage, or to test and maintain electrical or communication systems, often rectangular holes, or “portals,” are cut into the ceilings. Such ceilings are often made from plasterboard, gypsum, sheetrock, drywall, and wood, as non-limiting example. Typically, rectangular boards having the same length and width as those of the portals, are cut, perhaps from the same material used for the associated ceilings, to cover the portals, when access to spaces above the portals is not needed. Such boards, used to cover the ceiling portals, the closure panels, are often known as “ceiling access panels.”

Frames are often built into the ceilings adjacent the ceiling panels for at least two purposes. One purpose of the frames is to reinforce the ceilings at the edges of the portals. Another common purpose of the frames is to support the closure panels with the frames and to maintain their positions flush with the ceilings.

The present inventors developed an inexpensive frame for ceiling access panels that is both easy and fast to install.

### SUMMARY

The invention is an improvement over prior technology portal frames. Embodiments of the present invention do not require nailing, screwing, drilling, or bonding of frame materials to a ceiling, but the frame nonetheless strengthens the edges of the ceiling portal.

The invention may be embodied as a frame for a ceiling access panel. The frame has four edge members and four corner members. The four edge members each have first, second, and third surfaces. The first surface is coplanar with the second surface and parallel to and facing the third surface. Two of the edge members have a first length, and two of the edge members have a second length. The first and second lengths can be equal, but such is not required. The four corner members couple with the edge members. Each of the edge members and the corner members may have at least two connector pieces such that connector pieces of the edge member couple with connector pieces of the corner members to effect the coupling of the corner members to the edge members. Some of the connector pieces may be protrusions, and some may be recessions, but such is not required. If the connector pieces are protrusions, they may extend perpendicularly to planes of the first, second, and third planar surfaces and also perpendicularly to the direction of the lengths of the edge members.

The invention may also be embodied as a method of constructing a frame around a ceiling portal for a ceiling access panel, the ceiling portal having four edges and four corners. The method includes: sliding a first edge member having first, second, and third surfaces onto a first edge of the ceiling portal such that the first and third surfaces are parallel and contact the ceiling therebetween, the second surface being coplanar with the first surface and extending away from the portal first edge; sliding a second edge member having first, second, and third surfaces onto a second edge of the ceiling portal such that the first and third surfaces are parallel and contact the ceiling therebetween, the second surface being coplanar with the first surface and extending away from the portal second edge; sliding a third edge member having first, second, and third surfaces onto a third edge of the ceiling portal such that the first and third surfaces are parallel and contact the ceiling therebetween, the second surface being coplanar with the first surface and extending away from the portal third edge; sliding a fourth edge member having first, second, and third surfaces onto a fourth edge of the ceiling portal such that the first and third surfaces are parallel and contact the ceiling therebetween, the second surface being coplanar with the first surface and extending away from the portal fourth edge. The method also includes: coupling first, second, third, and fourth corner members each to a different pair of adjacent edge members. Accordingly, the second surfaces of the first, second, third, and fourth edge members form a support for a closure panel for the ceiling portal.

In some implementations of this method, the corner members each have portal corner abutments protruding from planar surfaces; and the corner members are coupled to the pairs of edge members by bringing the portal corner abutments into contact with the ceiling portal corners, thereby aligning connector pieces of the edge members with connector pieces of the corner members to execute the coupling.

Embodiments of the present invention are described in detail below with reference to the accompanying drawings, which are briefly described as follows:

### BRIEF DESCRIPTION OF THE DRAWINGS

The invention is described in more detail below and illustrated in the following drawings. The drawings are exemplary and not necessarily to scale.

FIGS. 1A, 1B, and 1C provide a top view, a side view, and a perspective view, slightly from the bottom, of an edge member according to one embodiment of the invention;

FIG. 1D provides a cross-sectional view of the edge member of FIGS. 1A-1C corresponding to the A-A line in FIG. 1A;

FIGS. 2A, 2B, and 2C provide a bottom view, an upside-down side view, and a perspective view, slightly from the bottom, of a corner member according to the embodiment of FIGS. 1A-1C;

FIG. 3 provides a perspective view, somewhat from the top, of the embodiment with its individual edge and corner members in the pre-assembly state;

FIG. 4 provides a side view of the embodiment;

FIG. 5 provides a bottom view of the embodiment;

FIG. 6 provides a top view of the embodiment;

FIG. 7 provides perspective view of the embodiment, somewhat from the top; and

FIG. 8 presents a flow chart representing the invention embodied as a method of constructing a frame around a ceiling portal for a ceiling access panel.

### DETAILED DESCRIPTION

Reference is repeatedly made below to specific figures in the present detailed description when discussing specific features of an embodiment. However, most structural elements of an embodiment are illustrated in multiple figures, so reference to all figures depicting the particular element is inherent.

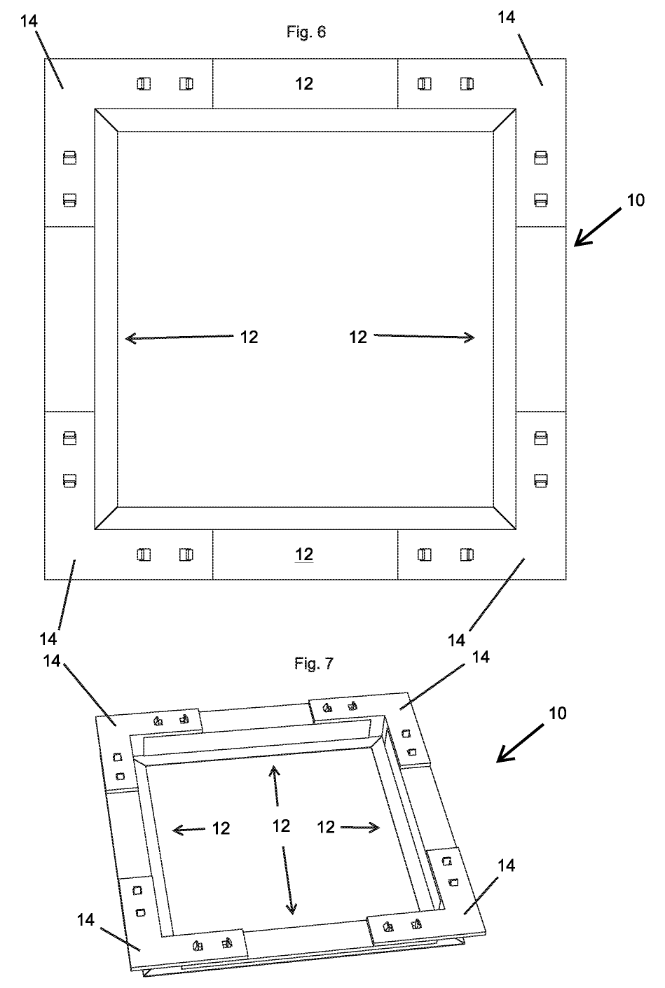

The present invention may be embodied as a frame for a ceiling access panel. A bottom view of such frame 10 is provided in FIG. 5, and a top view is provided in FIG. 6. The view provided in FIG. 3 of the embodiment’s pre-assembly state shows that the frame 10 has four edge members 12 and four corner members 14. The frame’s edge member 12 and corner member 14 materials may be made of plastic or metal, as non-limiting examples. One skilled in the art can select the engineering plastic, such as thermoplastic, or metal that meets the strength requirements of a particular use.

The frame’s edge members 12 have lengths that correspond to the lengths of the edges of the ceiling portal or ceiling access panel. The term “length” in this context references the greatest dimension of the edge member, generally perpendicular to the width and height, or alternatively the length references the distance between two ceiling portal corners. Many sizes may be accommodated. As a non-limiting example, two edge members can have a first length associated with a 24-inch portal edge while the other two edge members can have a second length associated with 12-inch portal edges. Alternately, for square ceiling portals, all four edge members 12 could have the same length, for example, 12 inches or 24 inches.

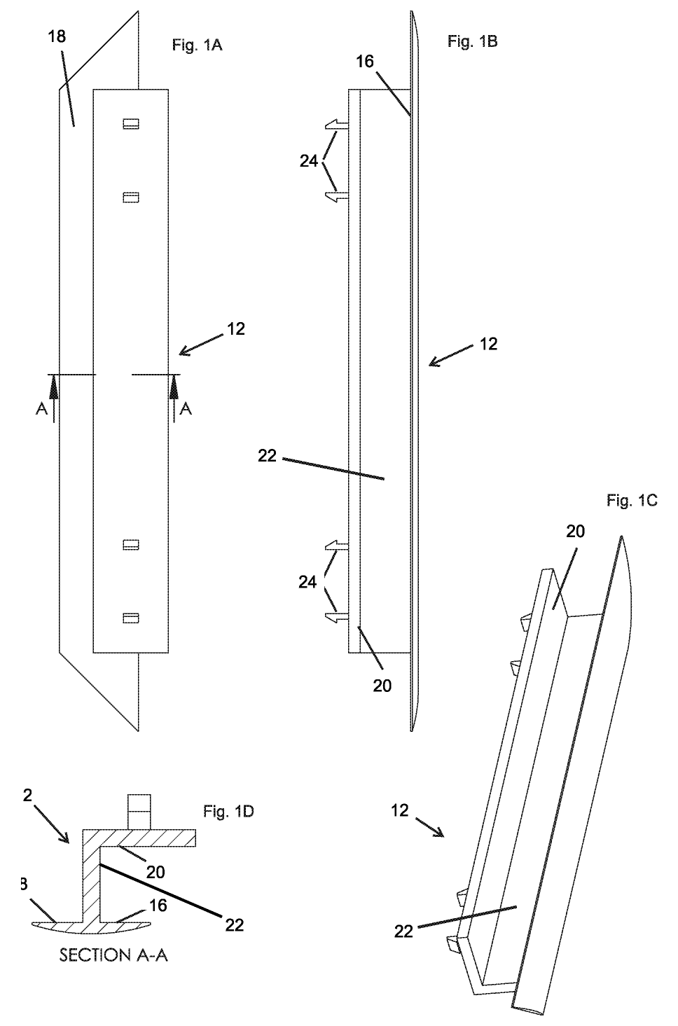

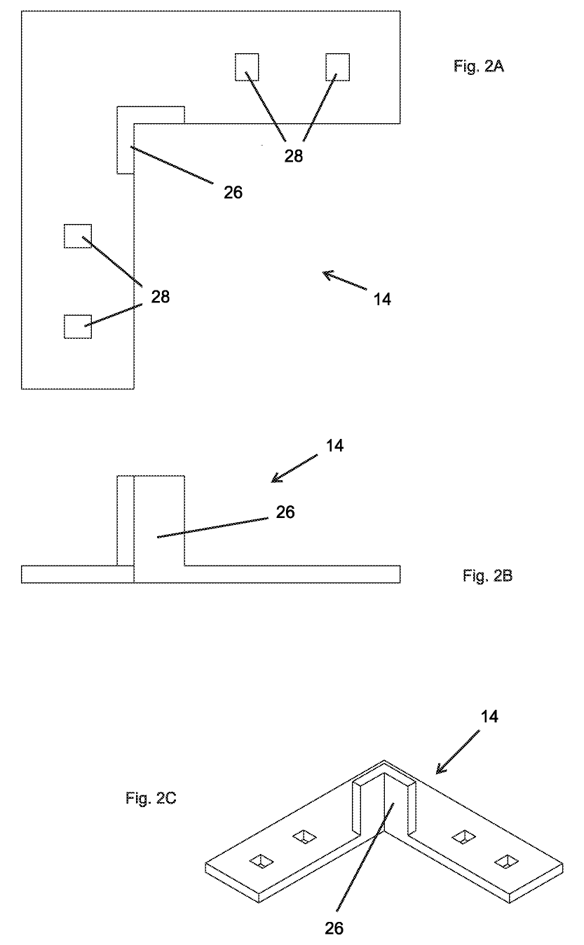

Reference is now made to the cross-section of FIG. 1D to discuss various surfaces of edge member 12. As the drawing shows, a first surface 16 is coplanar with a second surface 18, and the first surface 16 is also parallel to and facing a third surface 20. A portal edge abutment surface 20 connects between the first and third surfaces 16, 20. Also, as discussed below, the first and third surfaces 16, 20 of the edge member 12 contact/grip the bottom and top surfaces, respectively, of a ceiling at the portal edge. Accordingly, the distance between the first and third surfaces 16, 20 are approximately the thickness of the ceiling material. As also discussed below, the second surface 18 contacts and supports the ceiling access panel, so accordingly it is made to be strong enough to bear the access panel’s weight.

In this embodiment, the edge members each have four connector pieces 24, as shown for example, in FIG. 1B. The edge members of other embodiments may have as few as two connector pieces, may have three connector pieces, or may have even more than four connector pieces. In this embodiment, the connector pieces 24 protrude from the main body of the edge member 12, extending perpendicularly to the edge member’s length and also perpendicularly to planes of the first, second, and third planar surfaces 16, 18, 20.

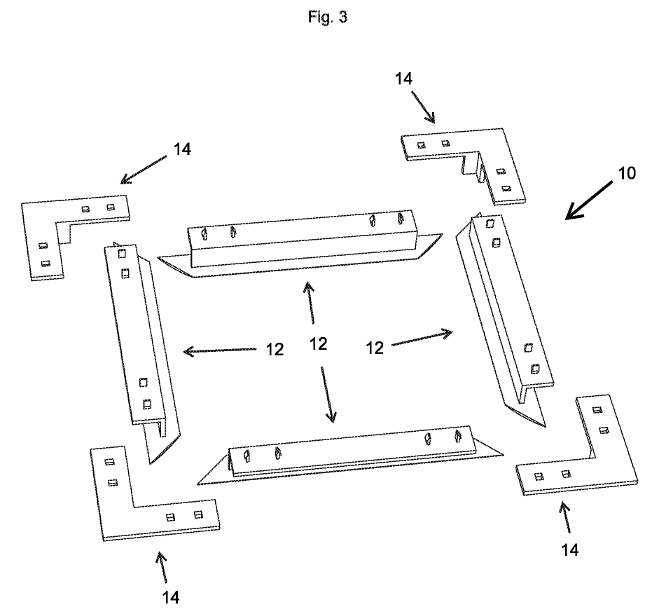

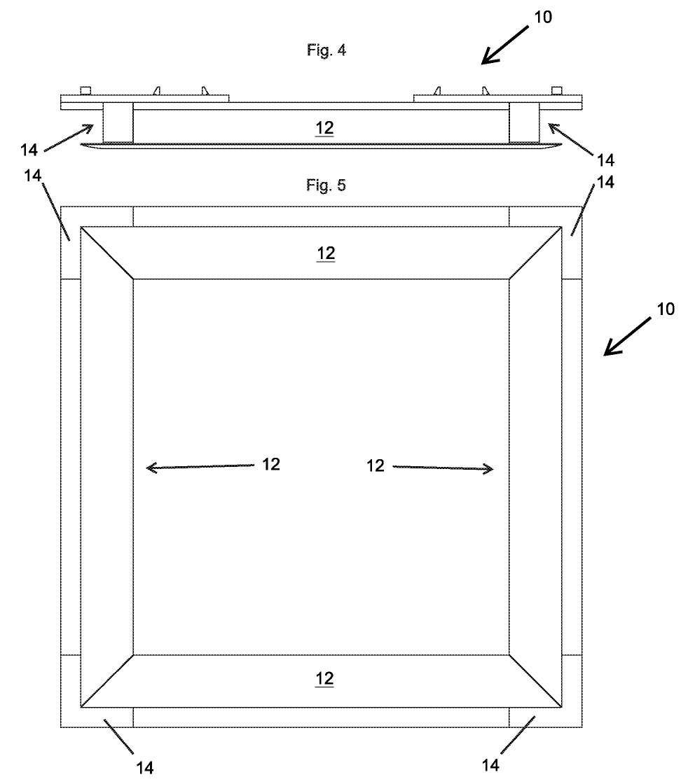

Reference is made to FIGS. 2A-2C to discuss the corner members 14, which are illustrated upside down to show the elements more clearly. A corner member 14 has a generally planar shape, resembling an “L,” with a protruding element, a portal corner abutment 26. As discussed below, this element protrudes to abut a corner of the ceiling portal.

As with the edge members 12, each corner member 14 in the present embodiment has four connector pieces 28. The corner members of other embodiments may have as few as two connector pieces, may have three connector pieces, or may have even more than four connector pieces. In this embodiment, the connector pieces 28 are holes in the generally-planar “L”-shaped portion, and they are positioned to couple with the connector pieces 28 of the edge members 12. Referencing again FIG. 1B it is seen that the protruding connecting pieces 28 of the edge members 12 can lock the edge members 12 and the corner members 14 together when the protruding connector pieces 28 advance sufficiently into the corresponding holes 28 of the corner members 14 to lock into place.

In alternate embodiments, the connecting pieces may be recessions that are not through holes, and other combinations of connecting pieces coupling edge and corner pieces may be implemented without departing from the spirit and scope of the invention.

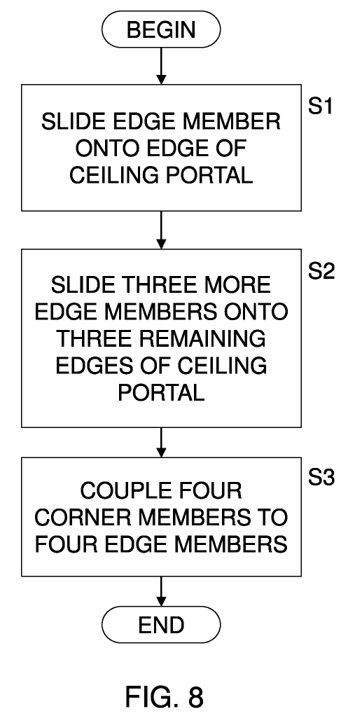

The invention may also be embodied as a method of constructing a frame around a ceiling portal for a ceiling access panel that has four edges and four corners. As discussed next, executing the method connects edge members to ceiling portal edges and connects corner members to the edge members adjacent the ceiling portal corners. Reference is made to the flow chart in FIG. 8 representing such an embodiment.

In this embodiment, the method begins by sliding an edge member, such as edge member 12 illustrated in FIGS. 1A-1C, onto an edge of the ceiling portal. (Step S1.) The edge member has first, second, and third surfaces and a portal edge abutment surface, such as shown in FIG. 1D, and the edge member is slid onto the ceiling portal edge in such a way that the first and third surfaces, which are parallel, contact the ceiling therebetween, and the portal edge abutment surface contacts the cut-away edge of the ceiling portal. The second surface of the edge member is coplanar with the first surface, and after installation the second surface extends away from the portal first edge toward the center of the portal.

Then, in a manner analogous with the previous step, three more edge members are slid onto the three remaining edges of the ceiling portal. (Step S2.) Each of the three additional edge members has first, second, and third surfaces and a portal edge abutment surface as the first edge member has.

With the edge members in place, four individual corner members, such as corner member 14 illustrated in FIGS. 2A-2C, are each coupled to a different pair of adjacent edge members. (Step S3.) Accordingly, the second surfaces of the four edge members are secured to extend toward the middle of the ceiling portal with sufficient strength to form a support for a closure panel for the ceiling portal, as shown in FIGS. 6 and 7.

In alternate embodiments, the order of assembling components may vary. For example, two edge members may be slid onto adjacent portal edges and then coupled to a corner member before the other two edge members are slid onto portal edges.

Optionally, the corner members may be constructed having portal corner abutments protruding from planar surfaces, such as portal corner abutment 26 shown in FIG. 2C. Corner members constructed accordingly may be coupled to pairs of adjacent edge members by bringing the portal corner abutments into contact with the ceiling portal corners. With the edge members having connector pieces suitably located and the corner members having corresponding connector pieces, also suitably located, bringing the portal corner abutments into contact with the ceiling portal corners aligns the connector pieces of the edge members with connector pieces of the corner members to execute the coupling of the edge and corner pieces.

Having thus described exemplary embodiments of the invention, it will be apparent that various alterations, modifications, and improvements will readily occur to those skilled in the art. For example, the edge and corner member can be made from wood. As another example, the edge members can be made without the second surfaces extending toward the middle of the portal. Alternations, modifications, and improvements of the disclosed invention, though not expressly described above, are nonetheless intended and implied to be within spirit and scope of the invention. Accordingly, the foregoing discussion is intended to be illustrative only.

What is claimed is:

1. A frame for a ceiling access panel, the frame comprising:
four edge members, each having first, second, and third surfaces, the first surface being coplanar with the second surface and parallel to and facing the third surface, two of the edge members having a first length and two of the edge members having a second length; and
four corner members that couple with the edge members.

2. The frame of claim ‎1, wherein the corner members each have portal corner abutments protruding from planar surfaces.

3. The frame of claim ‎1, wherein the first length and the second length of the edge connectors are equal.

4. The frame of claim ‎1, wherein each of the edge members and each of the corner members have at least two connector pieces such that connector pieces of the edge members couple with connector pieces of the corner members to effect the coupling of the corner members to the edge members.

5. The frame of claim ‎4, wherein some of the connector pieces are protrusions, and some of the connector pieces are recessions.

6. The frame of claim ‎5, wherein the protrusions extend perpendicularly to planes of the first, second, and third planar surfaces of the edge members.

7. A method of constructing a frame around a ceiling portal for a ceiling access panel, the ceiling portal having four edges and four corners, the method comprising:
sliding a first edge member having first, second, and third surfaces onto a first edge of the ceiling portal such that the first and third surfaces are parallel and contact the ceiling therebetween, the second surface being coplanar with the first surface and extending away from the portal first edge;
sliding a second edge member having first, second, and third surfaces onto a second edge of the ceiling portal such that the first and third surfaces are parallel and contact the ceiling therebetween, the second surface being coplanar with the first surface and extending away from the portal second edge;
sliding a third edge member having first, second, and third surfaces onto a third edge of the ceiling portal such that the first and third surfaces are parallel and contact the ceiling therebetween, the second surface being coplanar with the first surface and extending away from the portal third edge;
sliding a fourth edge member having first, second, and third surfaces onto a fourth edge of the ceiling portal such that the first and third surfaces are parallel and contact the ceiling therebetween, the second surface being coplanar with the first surface and extending away from the portal fourth edge; and
coupling first, second, third, and fourth corner members each to a different pair of adjacent edge members;
wherein the second surfaces of the first, second, third, and fourth edge members form a support for a closure panel for the ceiling portal.

8. The method of claim 7,
wherein the corner members each have portal corner abutments protruding from planar surfaces; and
wherein the corner members are coupled to the pairs of edge members by bringing the portal corner abutments into contact with the ceiling portal corners, thereby aligning connector pieces of the edge members with connector pieces of the corner members to execute the coupling.
